(19) United States
(12) Patent Application Publication
(10) Pub. No.: US 2009/0134086 A1
(43) Pub. Date: May 28, 2009

(54) Sealed rotational water treatment apparatus

(75) Inventor: Chi-Chang Kuo, Taichung City (TW)

Correspondence Address: Joe McKinney Muncy, PO Box 1364, Fairfax, VA, 22038-1364, US

(73) Assignee: New Century Membrane Co., Ltd.

(21) Appl. No.: 11/987,239

(22) Filed: Nov. 28, 2007

(51) Int. Cl. B01D 33/25; B01D 63/00

(52) U.S. Cl. 210/321.68; 210/331

(57) ABSTRACT

A sealed rotational water treatment apparatus is disclosed, and the sealed rotational water treatment apparatus includes a container, a power unit, a pipe shaft, and a plurality of filtering units. The container includes a sealed room, an inlet, an outlet away from the inlet, and a valve connected with the outlet. The power unit is set outside the container. The pipe shaft is connected with the power unit and set through the container, and includes a fluid collecting opening. The filtering units are mounted the external wall of the pipe shaft alternately and perpendicularly whereby the pipe shaft is driven by the power unit, and the filtering units are rotated around an axis.

### BACKGROUND

1. Field of Invention

The present invention relates to a water treatment apparatus, and more particularly to a sealed rotational water treatment apparatus

2. Description of Related Art

The conventional reverse osmosis assembly includes a net and two membranes wherein the net is clamped between the membranes. The reverse osmosis assembly is stacked with a mesh alternately, and the stacked layers of the reverse osmosis assembly and the mesh are rolled around a central tube in a pipe. The pipe is then installed within a ceramic sleeve and the opposite openings of the ceramic sleeve are covered with two lids to form a spiral membrane tube. The net support provides a reverse osmosis assembly with an internal fluid channel, and the adjacent reverse osmosis assemblies have another fluid channel there between parallel to the axis of the ceramic sleeve.

Water pumped by approximately 5-75 bar water pressure is fed into the ceramic sleeve and into the fluid channel through the meshes. In addition, the mesh results in a turbulent flow to prevent particle adhesion on the membrane when feeding water to the fluid channel. Therefore, the water molecule is dialyzed to the internal fluid channel through the membrane, and collected and guided out of the ceramic sleeve by the central tube such that the particles are kept in the fluid channel to generate a concentrated sewage capable of being drained away the ceramic sleeve.

The spiral reverse osmosis device has a larger unit area in a predetermined volume, but includes the following drawbacks:

1. Particle suspension may result in membrane fouling, and the filtered liquid amount depends on the number of membrane tubes. Although numerous membrane tubes can provide larger filtered liquid amounts, they also increase the equipment cost and occupied system volume.

2. The remaining concentrated sewage after filtration needs to be re-filtered and chemical processes must conform to the discharge standards. In this way, the process cost is raised and environmental pollution problem occurs.

3. The mesh reduces the dialysis area of the filtering membrane, and may detain deposit or mud to slow down the flow rate of the filtered liquid and deteriorate the filtration efficiency.

In addition, a conventional rotational water treatment device is half-immersed in an open tank. Because of the opening tank, the filtered fluid can only be collected by providing a negative pressure (vacuum extraction) such that the filtered fluid amount is too limited to apply to huge water treatment system.

Although adopting the water treatment system with full-immersed formation can boost filtered fluid amount, the stable flow in the tank may result in mud adhesion on the membrane surface because of the lack of shear stress between the fluid and the membrane surface. Besides, the high particle density of the fluid may generate concentration polarization effect.

As a result, raising the filtered fluid amount, preventing the fouling problem and reducing sewage discharge is the aim of the present invention.

### SUMMARY

It is therefore an aspect to provide a sealed rotational water treatment apparatus wherein the power unit drives the filtering units to rotate in a sealed room for filtration by feeding water of positive pressure. Consequently, the filtering membrane endures higher sewage turbidity, and the concentration polarization can be prevented to increase filtered fluid amount.

It is therefore another aspect to provide a sealed rotational water treatment apparatus using a control valve to control recycling water in the sealed room, which re-filters and reduces sewage discharge to conform to environmental protection demands.

It is therefore another aspect to provide a sealed rotational water treatment apparatus wherein the feeding water includes turbulent flow because of the protrusion design formed on the internal surface of the container. Hence, the turbulent flow of radial and axial directions prevents the membrane surface from fouling to extend the using period thereof.

In accordance with an embodiment of the present invention, the sealed rotational water treatment apparatus includes a container, a power unit, a pipe shaft, and a plurality of filtering units. The container includes a sealed room, an inlet, an outlet away from the inlet, and a valve connected with the outlet. The power unit is set outside the container. The pipe shaft is connected with the power unit and set through the container, and includes a fluid collecting opening. The filtering units are mounted the external wall of the pipe shaft alternately and perpendicularly whereby the pipe shaft is driven by the power unit, and the filtering units are rotated around an axis.

As a result, the sealed rotational water treatment apparatus of the present invention has the following effects:

1. The filtering units in the sealed room are rotated by the power unit such that the sewage turbidity endurance is increased and the mud adhesion problem of the membrane surface can be improved. In addition, the filtered fluid amount is increased by feeding water of positive pressure.

2. The control valve regulates the flow between the channel and the sealed room for fluid cycle and re-filtration to reduce sewage discharge and conform to environmental protection demands.

3. The flow in the sealed room has radial and axial directions to prevent the membrane surface from fouling to extend the using period thereof.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view of a sealed rotational water treatment apparatus of a first embodiment in accordance with the present invention;

FIG. 2 is a partial sectional view of the water treatment apparatus in FIG. 1;

FIG. 3 is a sectional view of the water treatment apparatus along the sectional line 3-3 in FIG. 2;

FIG. 4 is a schematic view illustrating fluid recycle of the first embodiment;

FIG. 5 is an enlarged partial sectional view of the container and the filtering units of the water treatment apparatus in FIG. 1;

FIG. 6 is side view of the water conducting disc of a sealed rotational water treatment apparatus of a second embodiment in accordance with the present invention;

FIG. 7 is a perspective view of the container in accordance with the second embodiment; and

FIG. 8 is a partial sectional view in accordance with the second embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

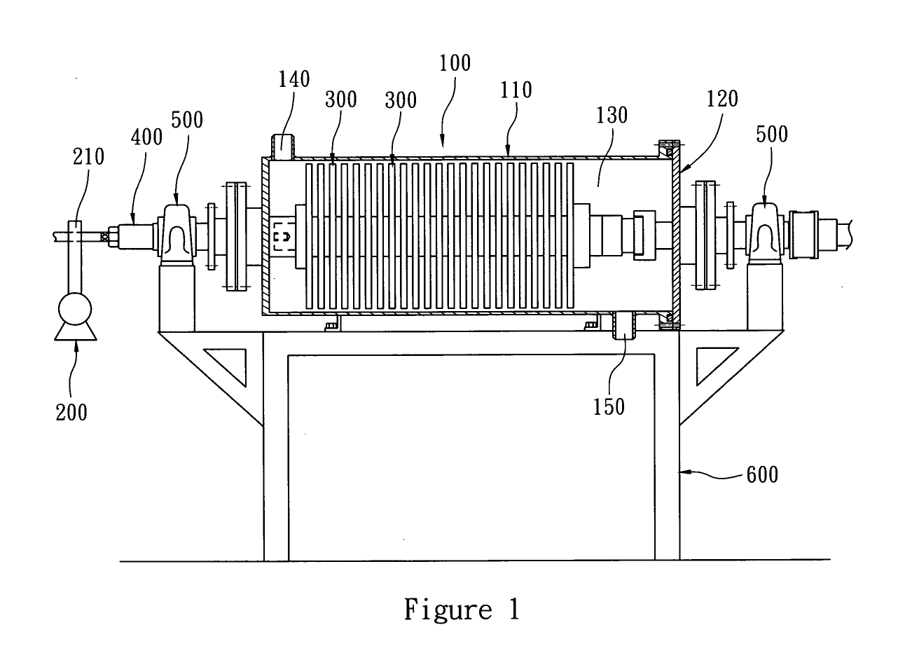

Refer to FIG. 1. The sealed rotational water treatment apparatus includes a container 100, a power unit 200, a plurality of filtering units 300, a pipe shaft 400, two bearings 500, and a base 600.

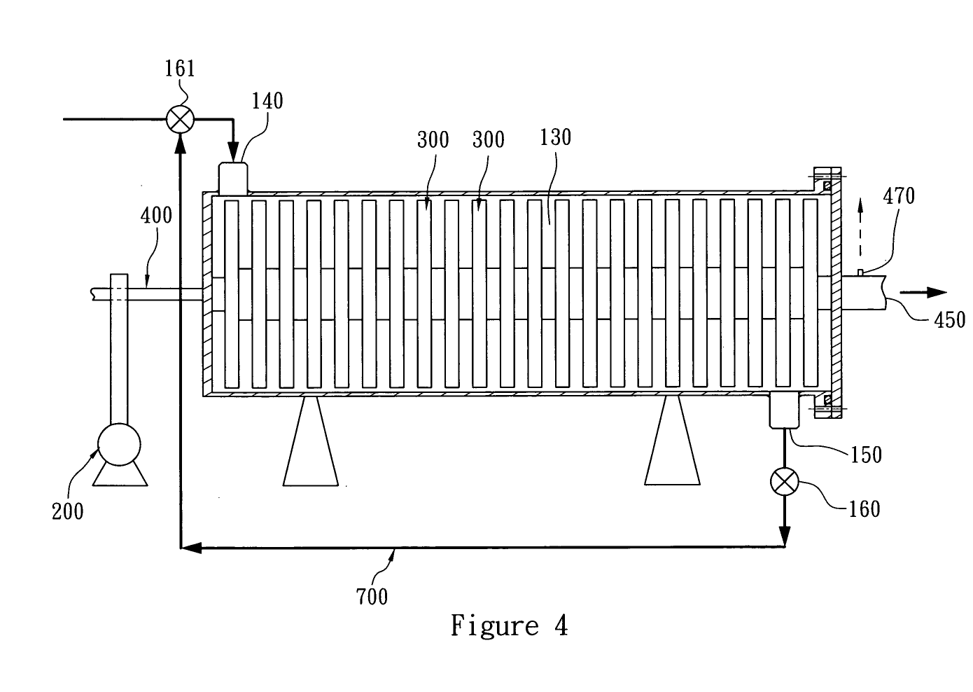

The container 100 includes a sealed room 130, an inlet 140, an outlet 150, and a valve 160. The sealed room 130 is defined by a case 110 and a cover 120. The inlet 140 and the outlet 150 are defined on the case 110 wherein the outlet 150 is away from the inlet 140. The valve 160 is connected with the outlet 150 (as shown in FIG. 4).

The power unit 200 is set outside the container 100, and is connected with the pipe shaft 400 wherein the power unit 200 is a reducer driving the pipe shaft 400 with a chain 210.

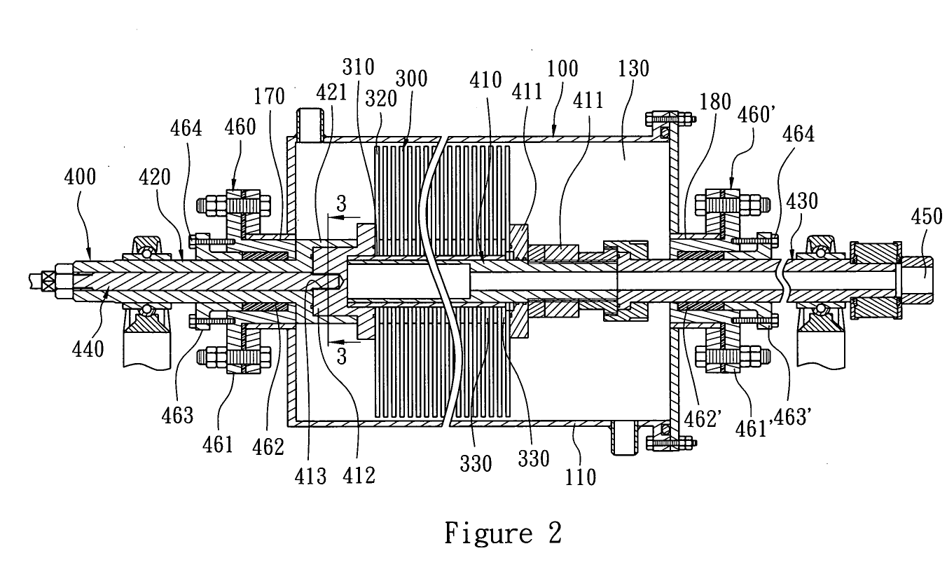

Refer to FIG. 2. The alternate, watertight filtering units 300 are mounted on the external wall of the pipe shaft 400. Each filtering unit 300 includes a central aperture 310, a filtering membrane member 320, and two water conducting discs 330 wherein the filtering membrane member 320 is perpendicular to an axis of the pipe shaft 400. The water conducting discs 330 clamp the filtering membrane member 320 and correspond to the central aperture 310.

The filtering membrane member 320 includes a supporting net, two clipping nets sandwiching the supporting net, and two filtering membranes sandwiching the clipping nets. The filtering membrane member 320 may use a conventional filtering membrane member, so a detailed description is omitted. In addition, the filtering membrane in this embodiment is a nano-filtration membrane, and hydrophilic materials of —OH group and —SO₃H group are added on the surface of the membranes to provide the membranes with a hydrophile effect to reduce mud or particle suspension adhesion.

The pipe shaft 400 is set through the container 100, and includes a hollow shaft 410, a first segment 420 and a second segment 430, a locking rod 440, and a fluid collecting opening 450. The hollow shaft 410 on which the filtering units 300 and the fastening members 411 are mounted is set through the central apertures 310 of the filtering units 300 to locate in the sealed room 130. The first segment 420 and the second segment 430 are respectively secured on opposite ends of the hollow shaft 410 and extend out of the container 100. The locking rod 440 penetrates the first segment 420 to secure the hollow shaft 410. The fluid collecting opening 450 communicates with the passageway of the hollow shaft 410 and the tubular second segment 430.

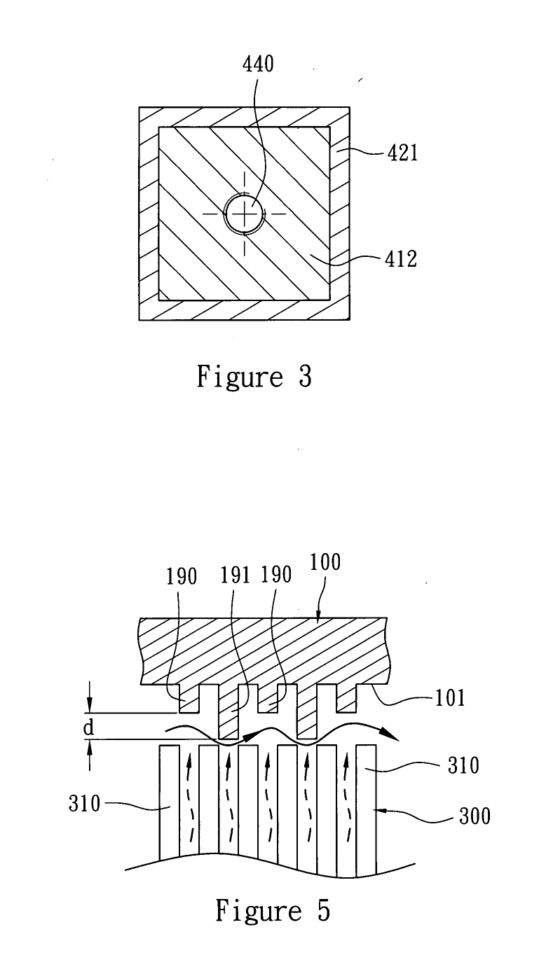

Moreover, the first segment 420 is fixed in a first axial hole 170 of the container 100 by a first locking assembly 460, and includes an embedded portion 421 extending inside the sealed room 130. The hollow shaft 410 includes a block 412 corresponding to the first axial hole 170 whereby the block 412 is embedded within the embedded portion 421 along the axis. The locking rod 440 is further fastened within a threaded hole 413 of the block 412 to connect the first segment 420 and the hollow shaft 410. In this embodiment, the corresponding block 412 and embedded portion 421 are illustrated in the form of a rectangle (Refer to FIG. 3).

The second segment 430 is fixed in a second axial hole 180 of the container 100 by a second locking assembly 460′, and secured on the other end of the hollow shaft 410 by fasteners.

The first locking assembly 460 for securing the first segment 420 includes a first disc 461, a first gasket 462, and a first plate 463. The first disc 461 is coupled in the first axial hole 170 of the container 100. The first gasket 462 is attached between the first segment 420 and the first disc 461. The first plate 463 is mounted against the first gasket 462 and fastened on the first disc 461 by fasteners 464.

The second locking assembly 460′ secures the second segment 430 and includes a second disc 461′, a second gasket 462′, and a second plate 463′. The second disc 461′ is coupled in the second axial hole 180 of the container 100. The second gasket 462′ is attached between the second segment 430 and the second disc 461′. The second plate 463′ is mounted against the second gasket 462′ and fastened on the second disc 461′ by fasteners 464.

The first gasket 462 or the second gasket 462′ is made of hard-wearing material, such as rubber, to prevent the container 100 from water leakage during the rotation of the first segment 420 and the second segment 430. After a long using period, the gasket (462 or 462′) may result in gaps because of the abrasion between the gasket and the segment (420 or 430). The gaps can be diminished by advancing the fasteners (464) to move the plate (463 or 463′) forward to further press against the gasket through the elasticity thereof.

Refer to FIG. 4. The sealed rotational water treatment apparatus further includes a channel 700 connected between the inlet 140 and the outlet 150 of the container 100. Therefore, the valve 160 connected with the outlet 150 regulates the fluid recycle in the sealed room 130 for re-filtration to prevent sewage discharge. In addition, the feeding water is provided into the sealed container 100 through the valve 161.

The pipe shaft 400 includes an exhaust 470 communicating with the fluid collecting opening 450 to expel air out of the container 100 from the hollow shaft 410 and the second segment 430. Hence, the air-lock effect can be prevented to enhance fluid dialysis of the filtering membrane member 320.

Refer to FIG. 1 and FIG. 4. The base 600 is used to support the container 100, the power unit 200, the filtering units 300, the pipe shaft 400, and the bearings 500. The bearings 500 respectively hold the pipe shaft 400 in the opposite ends to bear the power from the rotation of the pipe shaft 400. When the power unit 200 drives the pipe shaft 400 (intermittent or continuous forward/reverse), the filtering units 300 are rotated in the sealed room 130 by the pipe shaft 400 with 30-80 rpm rotation speed such that the mud adhesion on the membrane resulted from concentration polarization can be prevented. Compared with the conventional RO membrane, the nano-filtration membrane of the filtering units 300 in accordance with this embodiment has greater filtered liquid amount in the same operation period.

Refer to FIG. 5. The container 100 includes multiple protrusions 190 and 191 formed on an internal wall 101, and corresponding to the spaces between the adjacent filtering units 300 without touching the filtering units 300. The adjacent protrusions 190 and 191 include a drop height “d” to provide a waved liquid flow parallel to the axis near the internal wall 101. Beside, the radial liquid flow (shown as the dashed line) results from the rotation of the filtering units 300 intercrossing with the axial liquid flow to generate a turbulent flow effect. Consequently, the turbulent flow of radial and axial directions prevents the membrane surface from fouling to extend the using period thereof.

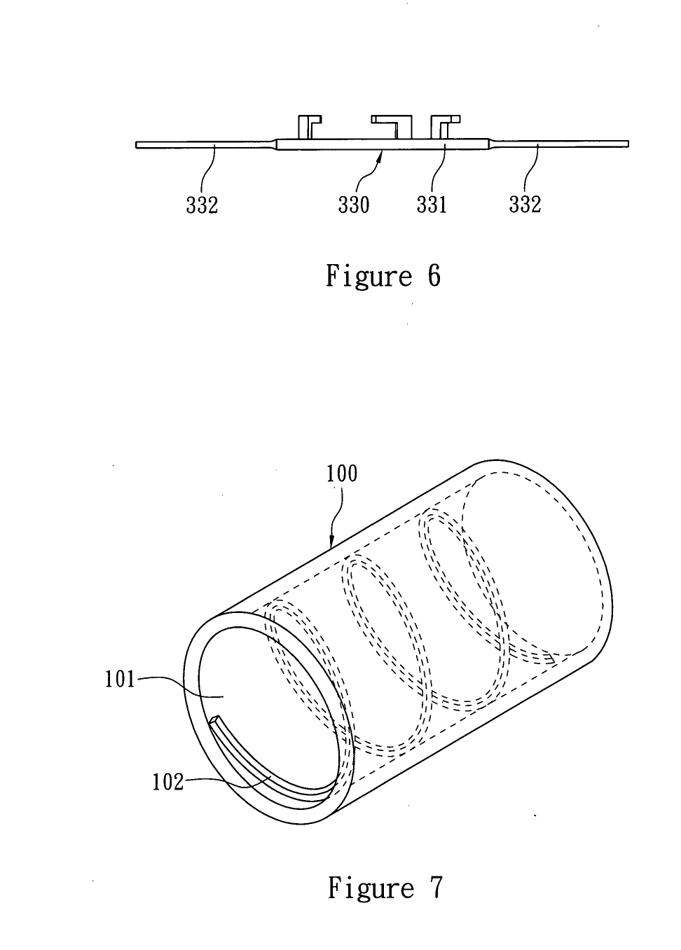

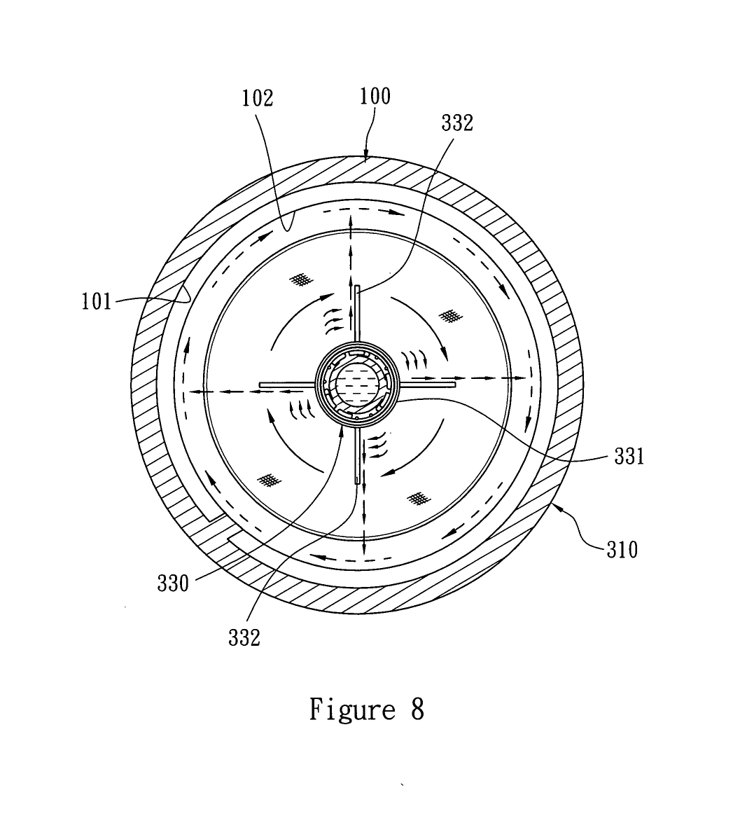

Refer to FIG. 6, FIG. 7 and FIG. 8. The second embodiment of the sealed rotational water treatment apparatus has the same structure to the first embodiment. The difference between the first and the second embodiment is that each water conducting disc 330 includes a circular body 331 and multiple ribs 332 extended radially from the circular body 331. In addition, the container 100 includes a protrusion 102 formed on and spiraled around the internal wall 101 along the axis.

Refer to FIG. 8. When the filtering units 300 rotate, the ribs 332 of the filtering units 300 stir the fluid between the filtering units 300 to form a circular flow, and the ribs 332 retain the circular flow to form a radial flow. Therefore, the circular flow interacts with the radial flow to provide turbulent flow effects. Beside, the circular flow between the filtering units 300 and the internal wall 101 of the container 100 also interacts with the protrusion 102 to enhance the turbulent flow in the container 100.

As embodied and broadly described herein, the sealed rotational water treatment apparatus has the following effects:

1. The filtering units 300 in the sealed room 130 are rotated by the power unit 200 such that the sewage turbidity endurance is increased and the mud adhesion problem of the membrane surface can be improved. In addition, the filtered fluid amount is increased by feeding water of positive pressure.

2. The valve 160 regulates the flow between the channel 700 and the sealed room 130 for fluid cycle and re-filtration to reduce sewage discharge and conform to environmental protection demands.

3. Because of the protrusions 190 and 191 or protrusion 102 formed on the internal wall 101 of the container 100 and the ribs 332 extended radially from the water conducting disc 330, the flow in the sealed room 130 has radial and axial directions. Consequently, the turbulent flow resulted from the radial and axial flows prevents the membrane surface from fouling to extend the using period thereof.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sealed rotational water treatment apparatus, comprising:
a container comprising a sealed room, an inlet, an outlet away from the inlet, and a valve communicating with the outlet;
a power unit set outside the container;
a pipe shaft connected with the power unit and set through the container, and comprising a fluid collecting opening; and
a plurality of filtering units mounted on an external wall of the pipe shaft alternately and perpendicularly whereby the pipe shaft is rotated by the power unit to rotate the filtering units around an axis of the pipe shaft.

2. The apparatus of claim 1, wherein the pipe shaft comprises a hollow shaft, a first segment, a second segment, and a locking rod wherein the hollow shaft is located in the sealed room, the first segment and the second segment are respectively secured on opposite ends of the hollow shaft and extending out of the container, and the locking rod is penetrated through the first segment to secure the hollow shaft.

3. The apparatus of claim 2, further comprising a first locking assembly and a second locking assembly respectively fix the first segment and the second segment on a first axial hole and a second axial hole of the container.

4. The apparatus of claim 3, wherein the hollow shaft comprises a block corresponding to the first axial hole, and the first segment comprises an embedded portion extending inside the sealed room whereby the block is embedded within the embedded portion.

5. The apparatus of claim 4, wherein the first locking assembly comprises a first disc coupled in the first axial hole, a first gasket attached between the first segment and the first disc, and a first plate mounted against the first gasket and fastened on the first disc.

6. The apparatus of claim 5, wherein the second locking assembly comprises a second disc coupled in the second axial hole, a second gasket attached between the second segment and the second disc, and a second plate mounted against the second gasket and fastened on the second disc.

7. The apparatus of claim 1, further comprising a channel connected between the inlet and the outlet whereby the valve regulates the fluid recycle between the sealed room and the channel.

8. The apparatus of claim 1, wherein the container comprises multiple protrusions formed on an internal wall of the container, and corresponding to a plurality of spaces between the adjacent filtering units without touching the filtering units.

9. The apparatus of claim 8, wherein the adjacent protrusions comprise a drop height.

10. The apparatus of claim 1, wherein the container comprises a protrusion formed on and spiraled around an internal wall of the container about the axis.

11. The apparatus of claim 10, wherein each of the filtering units comprises a filtering membrane member, a central aperture, and two water conducting discs clamping the filtering membrane member and corresponding to the central aperture.

12. The apparatus of claim 11, wherein each of the water conducting discs comprises multiple ribs extended radially from a peripheral of the water conducting disc.

13. The apparatus of claim 1, wherein the pipe shaft further comprises an exhaust communicating with the fluid collecting opening.

14. The apparatus of claim 1, further comprising multiple bearings and a base wherein the bearings hold the pipe shaft and are carried on the base.

15. The apparatus of claim 1, wherein the power unit is a reducer driving the pipe shaft by a chain.

16. The apparatus of claim 1, wherein the container comprises a case and a cover to define the sealed room.
